(19) United States
(12) Patent Application Publication
(10) Pub. No.: US 2023/0260228 A1
(43) Pub. Date: Aug. 17, 2023

(54) ADAPTIVE MIXED REALITY

(71) Applicant: Meta Platforms Technologies, LLC, Menlo Park, CA (US)

(72) Inventors: Zhang Jia, San Jose, CA (US); Jan Oberländer, Binningen (CH); Stefan Rüffer, Zürich (CH); Gian Diego Tipaldi, Zürich (CH)

(21) Appl. No.: 18/169,596

(22) Filed: Feb. 15, 2023

Related U.S. Application Data
(60) Provisional application No. 63/311,245, filed on Feb. 17, 2022.

(51) Int. Cl. G06T 19/00; G06T 19/20; G02B 27/01

(52) U.S. Cl. CPC G06T 19/006; G06T 19/20; G02B 27/0172; G06T 2219/2012

(57) ABSTRACT

One example method for adaptive mixed reality includes estimating ambient lighting conditions using one or more sensors; calibrating each of the one or more sensors spatially or spectrally; determining a color point based on the ambient lighting conditions; and modifying a mixed reality display based on the color point, wherein the mixed reality display comprises virtual reality (VR) content and pass-through (PT) content.

### CROSS-REFERENCE TO RELATED APPLICATIONS

This application claims priority to U.S. Provisional Patent Application 63/311,245, filed Feb. 17, 2023, titled “Adaptive Mixed Reality,” the entirety of which is incorporated herein by reference.

### FIELD

The present application generally relates to adaptive mixed reality, in particular to adaptive colors for virtual content for mixed realities.

### BACKGROUND

Mixed reality involves combining real world content with virtual content. Virtual reality headsets provide mixed reality to users by allowing pass through content to users with different amounts of virtual content. Current headsets provide mixed reality in grayscale only, however, as mixed reality transitions into color, numerous problems arise. For example, matching the color of virtual content with color of the real world pass through content.

### SUMMARY

Various examples are described for adaptive mixed reality. One example method includes estimating ambient lighting conditions using one or more sensors; calibrating each of the one or more sensors spatially or spectrally; determining a color point based on the ambient lighting conditions; and modifying a mixed reality display based on the color point, wherein the mixed reality display comprises virtual reality (VR) content and pass-through (PT) content.

One example system includes one or more sensors; a mixed reality display; one or more processors communicatively coupled to the one or more sensors and the mixed reality display; and a non-transitory computer-readable medium communicatively coupled to the one or more processors, wherein the one or more processors are configured to execute processor-executable instructions stored in the non-transitory computer-readable medium to estimate ambient lighting conditions using the one or more sensors; calibrate each of the one or more sensors spatially or spectrally; determine a color point based on the ambient lighting conditions; and modify the mixed reality display based on the color point, wherein the mixed reality display comprises virtual reality (VR) content and pass-through (PT) content.

One example non-transitory computer-readable medium comprising processor-executable instructions configured to cause one or more processors to estimate ambient lighting conditions using one or more sensors; calibrate each of the one or more sensors spatially or spectrally; determine a color point based on the ambient lighting conditions; and modify a mixed reality display based on the color point, wherein the mixed reality display comprises virtual reality (VR) content and pass-through (PT) content.

These illustrative examples are mentioned not to limit or define the scope of this disclosure, but rather to provide examples to aid understanding thereof. Illustrative examples are discussed in the Detailed Description, which provides further description. Advantages offered by various examples may be further understood by examining this specification.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying drawings, which are incorporated into and constitute a part of this specification, illustrate one or more certain examples and, together with the description of the example, serve to explain the principles and implementations of the certain examples.

FIG. 1 illustrates an example mixed reality system that includes a mixed reality headset with displays to provide a user with a view of a mixed reality environment in accordance with various embodiments.

FIG. 2 illustrates a flowchart of a color processing pipeline for generation of mixed reality, according to an embodiment herein;

FIG. 3 illustrates a scale of different ratios of VR content to PT content, according to an embodiment herein;

FIGS. 4A-4D depicts four images at varying ambient conditions in which the white point of the VR content is modified, according to an embodiment herein;

FIG. 5 depicts a chart of ranking results from experiment participants based on the images provided in FIGS. 4A-4D, according to an embodiment herein;

FIG. 6 depicts a color sphere, according to an embodiment herein;

FIGS. 7A-7D illustrate a flow for how adaptive mixed display may be provided, according to an embodiment herein;

FIG. 8 illustrates a graph is provided for determining a color temperature calibration, according to an embodiment herein;

FIGS. 9A-9F illustrate six images at varying ambient conditions in which the white point of the VR content is modified, according to an embodiment herein;

FIG. 10 depicts a graph based on the images provided in FIGS. 9A-9F, according to an embodiment herein;

FIG. 11 illustrates an example method for providing adaptive mixed reality; and

FIG. 12 shows an example computing device suitable for use with example systems and methods for adaptive mixed reality.

### DETAILED DESCRIPTION

Examples are described herein in the context of adaptive mixed reality. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

Mixed reality (“MR”) is a feature for virtual reality (“VR”) headsets. In VR, the direct view of outside real world is completely blocked and replaced by a display and a lens placed in front of the eyes. In contrast, MR is a combination of real-world pass-through content (“PT content”) with VR content. MR is generally achieved using front-facing sensors (e.g., cameras) mounted on VR headset to capture the PT content from the ambient environment. The MR can be independently generated using computer graphics and then overlayed onto the PT content on the VR display.

MR applications can combine PT content with VR content in a variety of ways. Conventionally, MR (e.g., the combination of PT content and VR content) is provided in grayscale. However, providing a MR in color can provide a user a much richer experience. As MR transitions from grayscale into color, the visual quality and color matching of VR content with PT content may become increasingly important. As color is added, user expectations on visual quality become significantly more complex, and there are more degrees of freedom. For example, human color perception is affected by color constancy and the tendency to perceive object colors approximately the same under varying illumination conditions. As a result, humans effectively adapt, to some extent, to the ambient illumination in their environment.

To generate a MR environment having a desirable color performance (e.g., the VR content visually matching or similar to the PT content), there are numerous factors to consider. The main two considerations include color point consistency and matching of virtual objects to the captured scene. The color point consistency generally includes scene or white point consistency between the real environment and the MR environment and object color or color temperature consistency between real objects and virtual options. Matching of virtual objections can include generating the virtual objects to naturally fit in the real scene. As should be appreciated, when used herein the term “real” refers to content (e.g., objects, scenes, environments) as present in the real world, the term “virtual” refers to graphically generated content, such as those used in VR, and the term “captured” refers to real content captured by the MR sensors and displayed on a VR display.

The color performance of a MR environment is impacted by the chromatic adaption mechanism of the human visual system. The chromatic adaptation mechanism in the human visual system in real world can automatically account for the variation of ambient illumination colors, with the perceived color appearance of surfaces remaining relatively constant. Electronic displays, however, are self-luminous, with the spectral composition of the light emitted from displays not varying with the ambient illumination. This difference can cause the color performance of MR environments to be negatively impacted.

MR is different from traditional displays viewed under an ambient illumination condition. In MR, users see the rendering of the captured environment merged with the graphically generated virtual contents on the headset display, as if the real environment and the residing virtual contents are viewed directly without the headset. However, users do not experience the real ambient lighting and display simultaneously as in traditional consumer products (e.g., phones, tablets). For MR, we expect similar adaptive display with its color (brightness and chromatic components) dynamically changing with the ambient illumination, particularly at the moment of putting on headsets. A more tolerant adaptive performance, however, is expected.

Moreover, the near eye displays in MR headsets generally have a lower luminance and cover a much larger field of view (FOV) with a darker surround. The effects of these differences have not been investigated in the past and are expected to affect the feature algorithm.

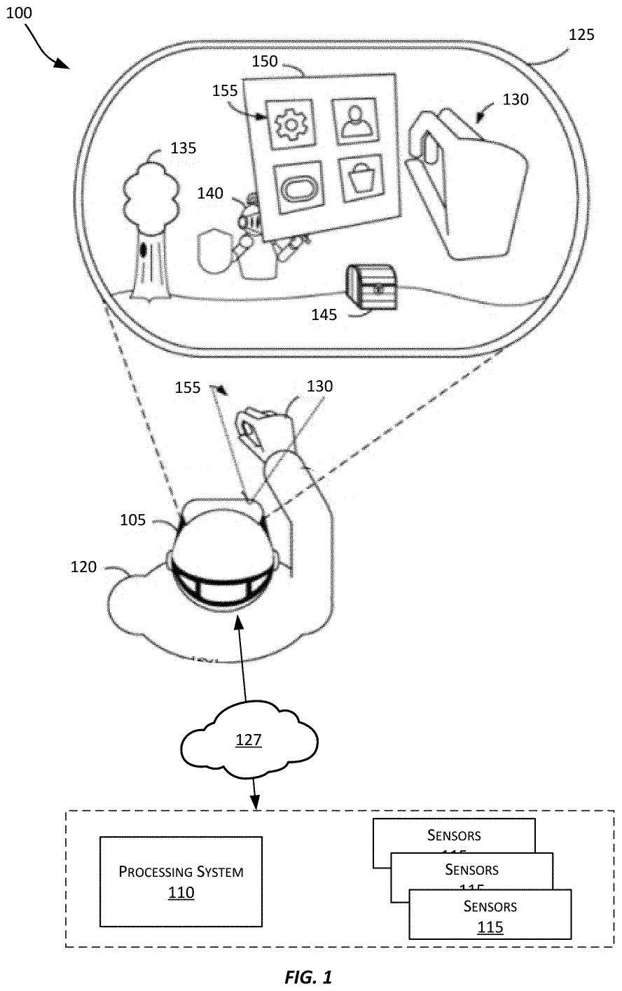

Referring now to FIG. 1, FIG. 1 illustrates an example client system 100 in accordance with aspects of the present disclosure. Client system 100 includes a MR system 105 (e.g., a head-mounted display (“HMD”)), a processing system 110, and one or more sensors 115. As shown, MR system 105 is typically worn by user 120 and comprises an electronic display (e.g., a transparent, translucent, or solid display), optional controllers, and optical assembly for presenting MR content 125 to the user 120. The one or more sensors 115 may include motion sensors (e.g., accelerometers) for tracking motion of the MR system 105 and may include one or more image capture devices (e.g., cameras, line scanners) for capturing image data of the surrounding physical environment. In this example, processing system 110 is shown as a single computing device, such as a gaming console, workstation, a desktop computer, or a laptop. In other examples, processing system 110 may be distributed across a plurality of computing devices, such as a distributed computing network, a data center, or a cloud computing system. In other examples, processing system 110 may be integrated with the HMD 105. MR system 105, the processing system 110, and the one or more sensors 115 are communicatively coupled via a network 127, which may be a wired or wireless network, such as Wi-Fi, a mesh network or a short-range wireless communication medium such as Bluetooth wireless technology, or a combination thereof. Although MR system 105 is shown in this example as in communication with, e.g., tethered to or in wireless communication with, processing system 110, in some implementations MR system 105 operates as a stand-alone, mobile MR system.

In general, client system 100 uses information captured from a real-world, physical environment to render MR content 125 for display to the user 120. In the example of FIG. 1, the user 120 views the MR content 125 constructed and rendered by a MR application executing on processing system 110 and/or MR system 105. In some examples, the MR content 125 viewed through the MR system 105 comprises a mixture of real-world imagery (e.g., the user's hand 130 and physical objects 135) and virtual imagery (e.g., virtual content such as information or objects 140, 145 and virtual user interface 150) to produce MR and/or augmented reality. In some examples, virtual information or objects 140, 145 may be mapped (e.g., pinned, locked, placed) to a particular position within MR content 125. For example, a position for virtual information or objects 140, 145 may be fixed, as relative to one of walls of a residence or surface of the earth, for instance. A position for virtual information or objects 140, 145 may be variable, as relative to a physical object 135 or the user 120, for instance. In some examples, the particular position of virtual information or objects 140, 145 within the MR content 125 is associated with a position within the real world, physical environment (e.g., on a surface of a physical object 135).

In the example shown in FIG. 1, virtual information or objects 140, 145 are mapped at a position relative to a physical object 135. As should be understood, the virtual imagery (e.g., virtual content such as information or objects 140, 145 and virtual user interface 150) does not exist in the real-world, physical environment. Virtual user interface 150 may be fixed, as relative to the user 120, the user's hand 130, physical objects 135, or other virtual content such as virtual information or objects 140, 145, for instance. As a result, client system 100 renders, at a user interface position that is locked relative to a position of the user 120, the user's hand 130, physical objects 135, or other virtual content in the MR environment, virtual user interface 150 for display at MR system 105 as part of MR content 125. As used herein, a virtual element ‘locked’ to a position of virtual content or physical object is rendered at a position relative to the position of the virtual content or physical object so as to appear to be part of or otherwise tied in the MR environment to the virtual content or physical object.

During operation, the MR application constructs MR content 125 for display to user 120 by tracking and computing interaction information (e.g., tasks for completion) for a frame of reference, typically a viewing perspective of MR system 105. Using MR system 105 as a frame of reference, and based on a current field of view as determined by a current estimated interaction of MR system 105, the MR application renders MR content 125 which, in some examples, may be overlaid, at least in part, upon the real-world, physical environment of the user 120. During this process, the MR application uses sensed data received from MR system 105 and sensors 115, such as movement information, contextual awareness, and/or user commands, and, in some examples, data from any external sensors, such as third-party information or device, to capture information within the real world, physical environment, such as motion by user 120 and/or feature tracking information with respect to user 120. Based on the sensed data, the MR application determines interaction information to be presented for the frame of reference of MR system 105 and, in accordance with the current context of the user 120, renders the MR content 125.

Client system 105 may trigger generation and rendering of virtual content based on a current field of view of user 120, as may be determined by real-time gaze 155 tracking of the user, or other conditions. More specifically, image capture devices of the sensors 115 capture image data representative of objects in the real world, physical environment that are within a field of view of image capture devices. During operation, the client system 100 performs object recognition within image data captured by the image capture devices of MR system 105 to identify objects in the physical environment such as the user 120, the user's hand 130, and/or physical objects 135. Further, the client system 100 tracks the position, orientation, and configuration of the objects in the physical environment over a sliding window of time. Field of view typically corresponds with the viewing perspective of the MR system 105. In some examples, the MR application presents MR content 125 comprising MR and/or augmented reality.

As illustrated in FIG. 1, the MR application may render virtual content, such as virtual information or objects 140, 145 on a transparent display such that the virtual content is overlaid on real-world objects, such as the portions of the user 120, the user's hand 130, physical objects 135, that are within a field of view of the user 120. In other examples, the MR application may render images of real-world objects, such as the portions of the user 120, the user's hand 130, physical objects 135, that are within field of view along with virtual objects, such as virtual information or objects 140, 145 within MR content 125. In other examples, the MR application may render virtual representations of the portions of the user 120, the user's hand 130, physical objects 135 that are within field of view (e.g., render real-world objects as virtual objects) within MR content 125. In either example, user 120 is able to view the portions of the user 120, the user's hand 130, physical objects 135 and/or any other real-world objects or virtual content that are within field of view within MR content 125. In other examples, the MR application may not render representations of the user 120 and the user's hand 130; and instead only render the physical objects 135 and/or virtual information or objects 140, 145. As discussed above, a difficulty with MR displays is that virtual objects rendered within a real environment presented in an MR display do not integrate with real-world objects due to differences in lighting and coloring between the virtual and real objects.

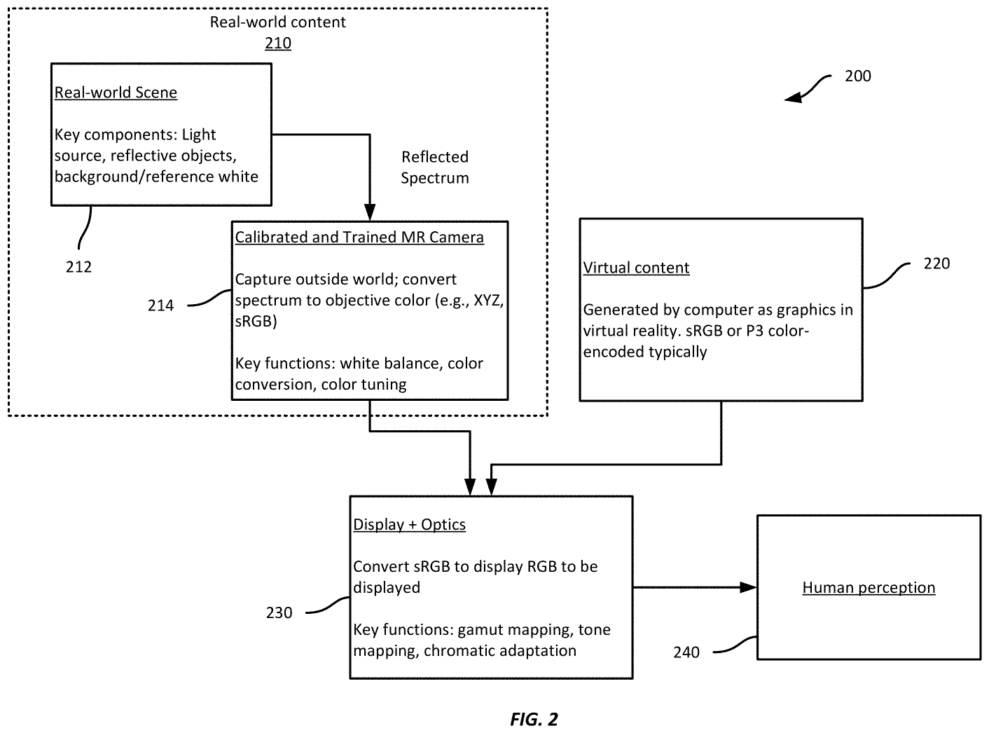

Referring now to FIG. 2, FIG. 2 shows an example color processing pipeline 200 for generating MR in a MR headset, e.g., MR HMD 105. As can be seen, the color processing pipeline 200 can include multiple inputs or properties that are used to generate the MR content. Within a MR environment, users may expect the PT content and the VR content to appear consistent with each other, such as in illumination and coloring. If VR and PT content are illuminated inconsistently, the suspension of disbelief may be broken and comfort levels may be lower, thereby negatively impacting the virtual experience. Accordingly, to improve or achieve a positive virtual experience, the color of the displayed VR content should be similar or close to the color of the PT content.

To generate VR content that has similar coloring and illumination to the PT content generated from the ambient environment of a user, a variety of factors are used to generate the VR content. As illustrated, the pipeline 200 may include input from the real-world scene 212. The input may include lighting data (e.g., illumination data) from the ambient environment of the user, which may include the spectra of any light sources in the environment, reflectivity of different objects visible in the scene, and background and reference information, such as white balance.

The real-world scene 212 may then be captured by a MR camera on a user device, such as the HMD 105 shown in FIG. 1. In this example, the MR camera has been calibrated and trained to operate both as an image capture device but also to operate as a sensor to detect light sources, including their locations, sizes, correlated color temperature (“CCT”), and RGB readings for white balance. The light source information can then be used later in the pipeline to match MR content to PT content as described in more detail below.

In addition to the captured real-world content, the MR system 100 generates virtual content 220, which may include any suitable virtual content for the particular context. Virtual content 220 may include information overlays within the user's field of view, such as annotations within a scene (e.g., names of visible objects or landmarks, directional or navigational information, etc.), or it may include virtual objects that appear positioned within the real environment. Once the virtual content is generated, it may be provided, along with the captured real-world content, to the display and optics functionality 230 to convert the received MR and PT information into a consistent color mapping between the two sets of information. The scene may then be output to the user, such as on a HMD, who can perceive the MR scene.

To match MR content to PT content within a MR environment, a color point may be used. The color point of content, one or both of the PT content and the MR content, can include a white point of the content and a color temperature of the content. For example, a white point is a measure of the color of ambient lighting, such as may be determined by the MR camera as discussed above. A white point (often referred to as reference white or target white in technical documents) is a set of tristimulus values or chromaticity coordinates that serve to define the color “white” in image capturing, encoding, or reproduction. For example, common examples of different white points are “warm white” and “cool white” in contrast to “daylight.” For example, photographs taken indoors may be lit by incandescent lights, which are relatively orange compared to daylight.

Depending on the application, different definitions of white may be needed to give acceptable results. Defining “white” as daylight may give unacceptable results when attempting to color-correct a photograph taken with incandescent lighting. In the MR context, discrepancy between the white point of the VR content (e.g., D65 or 6500K) and the PT content (e.g., 2700K) can result in an unnatural contrast and an uncomfortable transition for a user. In another scenario, the source of the PT content and the source of the VR content may be subject to different ambient lighting. As a result, the combined content may be perceived as inconsistent. Thus, by using the sensing capabilities of the MR camera to detect light sources and their respective spectra, a more accurate estimation of a scene's white point may be made.

Another factor that may be used to measure and calibrate the color of PT content with VR content is color temperature. Color temperature is a way to describe the light appearance provided by ambient lighting conditions, such as from a light bulb. Color temperature is often measured in degrees of Kelvin (K) on a scale from 1,000 to 10,000. For example, warm lighting is often considered to provide a cozy and inviting ambience. The color temperature of warm white is generally around 2000-3000K. In contrast, cool white is often considered to provide a lively and welcoming ambience. The color temperature of cool white is generally around 3000-4500K. In further contrast, daylight is often considered to provide a crisp and invigorating ambience. The color temperature of daylight is generally above 4500K. Accordingly, the type of ambient lighting condition will not only vary based on the ambience provided but it will also vary by white point and color temperature.

Conventional methods to providing chromatic adaptive displays involve sensing X and Y color using a full chromatic adaptive pipeline for X, Y, and Z adaptations. Conventional methods, however, suffer from large sensitivity errors. In contrast, the methods herein that are based on white point and/or color temperatures of ambient lighting conditions, may allow for the display to be driven by a predefined algorithm. The predefined algorithm, as described in greater detail below, may match a sensor's Red-Green-Blue (RGB) rating to an expected color temperature scale. Using a color temperature scale for chromatic adaptation may provide for a more stable MR adaptation over conventional methods. For example, once the color temperature of the ambient environment is sensed, a predefined curve can be used to adjust the VR content or the display color overall. Since using color temperature for chromatic adaptation is one-dimensional, it is more stable than the conventional three-dimensional (e.g., X, Y, and Z) approach.

To ensure that users are provided with an experience close to the real world during a MR session, examples systems and methods for providing an adaptive MR are described herein. To provide the adaptive MR in some examples, monochromatic PT may be used. The monochromatic pass-through described herein may provide for an enhanced user experience during a MR session. Moreover, the monochromatic pass-through may have relatively simple requirements—the image quality is largely determined by exposure, gain and gamma settings.

To address the color perception discrepancies between VR content and PT content, adaptive MR may start by using a MR camera to measure the ambient lighting conditions surrounding a MR user to estimate an ambient white point and ambient color temperature. For example, a MR headset may include one or more sensors that can be used to sense the ambient light conditions, which may include the MR camera itself, as discussed above. In some examples, the MR headset may include one or more dedicated sensors for sensing ambient lighting conditions, while in other examples, the existing sensors (e.g., cameras) may be used to sense ambient lighting conditions. In some examples, the sensor may include a camera. Since a camera does not have as broad of a range of light spectrum sensing capabilities as a sensor, the camera may need to be calibrated to provide the ambient lighting data. The ambient lighting data may be used to determine a white point of the ambient lighting and a color temperature of the ambient lighting.

The sensors may be calibrated spatially and spectrally. For spatial calibration, the one or more sensors used to gather ambient lighting data, which may include a white point and/or a color temperature of the ambient lighting, may be divided into one or more zones. Each of the zones may be individually calibrated. In some embodiments, a sensor may be or include a pixel or a cluster of pixels. The one or more zones may be used to gather the ambient lighting data. For example, if a color camera is used, the color camera may be divided into different zone or regions. The number of zones may vary depending on the sensor used or application being utilized. For example, the number of zones may range from 1 to 100, from 20 to 80, or from 40 to 70 zones. Each of those zones may be calibrated to be a color temperature and/or a white point sensor. In one example, to be a white point sensor, the zone may be calibrated to determine the brightness of an ambient lighting condition. The zone may be calibrated to different light and brightness intensities. A traditional color pipeline from the camera that includes white balance may be used for chromatic adaption. By utilizing traditional cameras and/or sensor equipment, the adoption of adaptive mixed realty may be done with minimal cost implications. For example, a user does not have to purchase new equipment that allows for adaptive MR. Instead, the established equipment can be updated to provide for an adaptive MR experience. In some examples a MR camera that has been calibrated and trained to detect light sources may be employed, though in some examples, light source detection may be determined off-camera, such as described above.

The sensors may be spatially calibrated using zones because each zone can allow the sensor to estimate a light source, intensity, and direction within the ambient environment. For example, a user may have a light source next to his or her on the left side and a dark room on the right side. By calibrating the different zones of the sensor, the sensor is able to spatially be calibrated to estimate the different ambient lighting conditions in the ambient environment. To spatially calibrate a sensor, the spatial and angular information of light entering the sensor may be determined. For example, the spatial and angular information of a light source may be determined by the size of the sensor and the number of pixels the light source is taking. For example, the spatial and angular information may be determined by determining the direction from which a light is entering into the sensor to a center point and how many pixels are lighting up.

Additionally, the sensors may be divided into different zones because different photodiodes, pixels, or sensing units within a sensor may have varying light sensitivity. Further, based on different in light sensitivity, one or more sensors may be re-configured to reduce their sensitivity or to scale the sensed information to better align with sensor data received from other sensors. By calibrating each zone individually, all the zones of a given sensor can be calibrated to provide uniform ambient lighting data, regardless of the zone's light sensitivity.

In some embodiments, the lighting data from each of the zones may be used to estimate a single white point for the PT content and the VR content. In such cases, the assumption may be that the environment is reasonably homogenous in terms of lighting conditions. The various zones of the sensor may be used to determine the relevant lighting information from the ambient environment. For example, back to the example above in which there is a light source on the left and a dark room on the right, it may be determined the lighting data corresponding to the light source is the applicable lighting data while the lighting data corresponding to the dark room is irrelevant. The applicable lighting data may then be used to adjust the MR environment (e.g., modify the PT content and/or the VR content). In some embodiments, a middle point between the lighting data for the light source and the lighting data for the dark room may be utilized. The zones provide the data for the adaptive MR system to determine the relevant information for adapting the PT and VR content.

To spectrally calibrate the sensor, the RGB ratings from the channels of the camera are calibrated so as to estimate a color temperature of the ambient lighting. Further, the sensor may capture lighting information for a period of time, such as over a period of 0.25 or 0.5 seconds, or over a period of multiple frames, e.g., 10-20 frames or a corresponding number of frames based on a frame rate of display data provided to the user and a period of time. Capturing data over time may help smooth any transient lighting effects, such as flashes from reflective surfaces, flashing lights, etc. By calibrating a sensor both spatially and spectrally, the sensor is able to determine the light source and what direction the light source is positioned in the ambient environment.

In an example, each of the zones of a sensor may be calibrated using different light sources to that mimic various ambient lighting conditions. Based on the different light sources, the zones are mapped between the RGB ratings of each zone to a CCT. This provides spectral information for each of the zones. In other words, a RGB input for each zone may be calibrated to an expected color temperature. Based on the RGB rating, a CCT rating can be determined and the adaptive MR can be provided using the CCT rating. The CCT rating may combine or provide for an estimate of the white point and the color temperature of the ambient lighting conditions.

Prior to providing a MR session, a user may be prompted to perform an initial setup to allow for estimation of the ambient lighting data. For example, a user may be prompted to put on the MR headset for a set period of time prior to entering a MR session. The set time period may range from seconds to minutes. During that time, the sensors may detect and determine the ambient lighting data based on their calibration, including the white point and/or color temperature.

During the initial set up, the sensors' sensitivity may be turned down, e.g., by reducing the gain or the exposure period, so that they do not become saturated with information from all the light sources. By turning down the sensitivity of the sensors, the true color information (e.g., color temperature) of the light sources may be readily determined. To account for the different light sources in a given ambient environment, a user may be prompted to move around the ambient environment so that the MR headset can build up a three-dimensional map of the various light sources and their corresponding lighting condition data.

Unlike conventional techniques, the adaptive MR approach performs white balancing based on a light source, not the entire ambient environment. This can allow a more accurate representation and adaption of the MR environment to the ambient lighting conditions. For example, if a user has a lamp next to the left and a window shining daylight to the right, the conventional approach would use either the lamp or the daylight for white balancing. This would not accurately reflect the actual lighting conditions. Because the sensors are spatially adapted, both light sources may be used for white balancing and color adaption, thereby providing a more accurate estimation of the ambient lighting conditions.

Using the white point of the PT content (“PT white point”), various MR variables may be determined. For example, the white point of VR content (“VR white point”) may be modified based on the PT white point. In some cases, the VR white point may be adjusted to match the PT white point. The PT white point may also be used to determine a color temperature of the VR content. For example, using the VR white point and/or the color temperature, the color of the VR content may be modified. In another example, based on the VR white point and/or the color temperature, a user of a MR headset may be notified to modify the ambient lighting conditions (e.g., turn on the lights or shut a window).

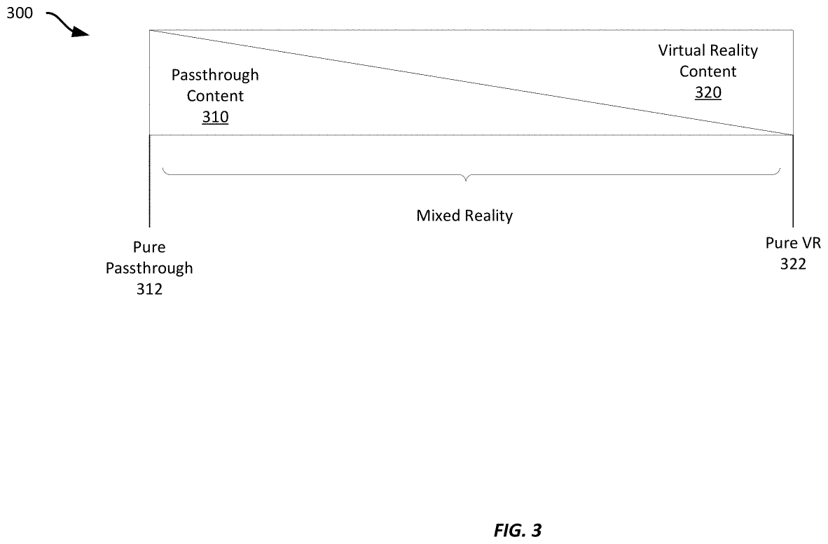

Numerous factors are considered when matching a white point of VR content with PT content and/or the color of the VR content with the PT content. For example, one factor may be the amount of VR content to PT content provided in the MR environment. Turning to FIG. 3, a scale 300 of different ratios of VR content 320 to PT content 310 is provided. As illustrated, different MR applications provide for different ratios of VR content 320 to PT content 310 thereby providing MR content. For example, pure passthrough 312 provides entirely PT content, while nearly pure PT content may include some limited virtual objects (e.g., with overlaid navigational information, such as a heading or overlaid street names). Further, while some applications provide for pure VR with no PT content at all, some heavily VR examples may include some limited PT information (e.g. showing your real desk/keyboard blended into a virtual desk in Workrooms). However, as illustrated in FIG. 3, the mixing of PT content 310 and VR content 320 may be done in any ratio suitable for a particular context. Thus, mixed reality presents a wide range of integration between PT content 310 and VR content 320.

The ratio of VR content to PT content may impact the modification of the VR content's white point and color. When VR and PT content is mixed, viewers will generally adapt their color perception based on the content that dominates the scene. For example, if the ratio of VR content to PT content is closer to 1, meaning that the MR environment is primarily VR content with a small amount of PT content (e.g., less than 5 percent), then the VR content may only be modified minimally based on the PT white point and color. In another example, when the VR content to PT content is close to 1, then the acceptable range of matching of the VR content to the PT white point and color may be larger. For example, the white point of the VR content may be within 75% of the PT white point. Since the VR content is the primary content rendering the MR environment, a user may be less likely to notice a color discrepancy with the PT content.

In contrast, when the ratio of the VR content to PT content is less than 0.5, meaning that the MR environment is majority PT content, then the VR content may be increasingly modified to match the PT content. For example, the VR content white point may be modified to be within 90% of the PT white point. Because the PT content is the primary content used to render the MR environment, a user may be more likely to notice a color discrepancy with the PT content.

The degree of matching of the VR content with the PT content may depend on the application or a user's preference. For example, a user may prefer the PT content's white point to be consistent with real ambient lighting white point, though not necessarily the same. They may also prefer a smooth transition between real ambient to desired virtual ambient color temperature. In another case, different MR applications may vary the VR content to attain a certain appearance. For example, different MR environments may use different ambient lighting to generate a particular mood. Thus, modifying the color scheme of the VR content may allow for customization of the ambience within a MR environment.

It should be appreciated that, as described herein, the phrase color scheme may correspond to a white point and/or color temperature. In some embodiments, the white point and color temperature may be corresponding factors for modifying the color scheme in an MR environment. For example, white point and color temperature may be proportional or interchangeable, depending on the application and calibration set-up.

As noted above, to provide a coherent MR environment with minimal color discrepancy between VR content and PT content, the MR headset may include one or more sensors for estimating the white point and color temperature of the ambient lighting conditions around the MR headset. Once the PT white point and PT color temperature are determined, the VR content may be modified based on the determined PT white point and color temperature. For example, the white point of the VR content or the color temperature of the VR content may be modified. For example, in a scenario in which the PT content is the primary content used to generate a MR environment, the PT content may include a scene with multiple objects. In an MR environment, an additional object may be added. However, the PT white point and color temperature affect the color perception of the objects in the scene and if the color temperature and the white point of any added VR object is not modified based on the ambient conditions of the PT content, the VR content may look out of place.

In some examples, once the VR content and the PT content are matched to a given white point and/or color temperature, the combined content (VR content plus PT content) may then be adjusted to a different white point and/or a different color temperature. Because the combined content has the same starting point, adjustment after they have been matched provides for cohesive and uniform adjustment for both the VR content and the PT content. Thus, an example system can change a white point of the VR content or PT content generated on in the MR environment based on ambient light, such within +/−600K to 1000K.

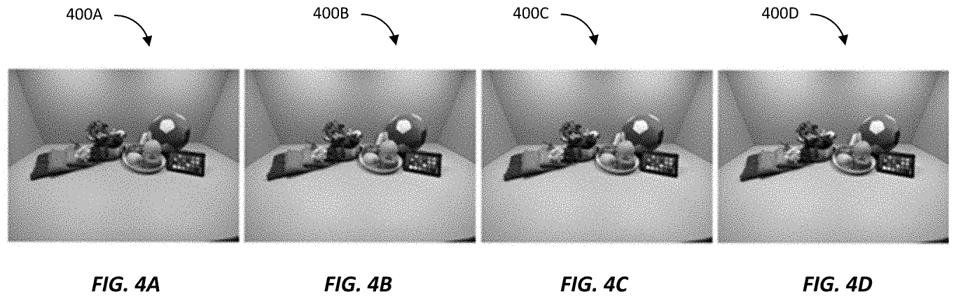

Referring now to FIGS. 4A-D and 5, FIGS. 4A-4D show an illustration of how changing a MR environment, including VR content and PT content, based on ambient lighting conditions can appear to the user. As illustrated, FIGS. 4A-4D provide four images at varying ambient conditions in which the white point of the VR content is modified. Each of the images in FIGS. 4A-4D were evaluated by experiment participants and asked to rate how close the VR content and the PT content is in each of the images. If the experiment participants considered the VR content and PT content to be completely different, a 5 rating was provided. If the experiment participants considered the VR content and PT content to have a large difference, a 4 rating was provided. If the experiment participants considered the VR content and PT content to have a noticeable but acceptable difference, a 3 rating was provided. If the experiment participants considered the VR content and PT content to have a little difference, a 2 rating was provided. If the experiment participants considered the VR content and PT content to be identical, a 1 rating was provided.

From the experiment, it was determined that providing a shadow to the VR content increases a participant's perception of the content's realness (e.g., perception that the VR content is PT content). It was also determined that the chromatic nature of objects did not affect a participant's rating. The brightness (e.g., lightness) of an object, however, effected the participant's rating (e.g., discernment between VR content and PT content).

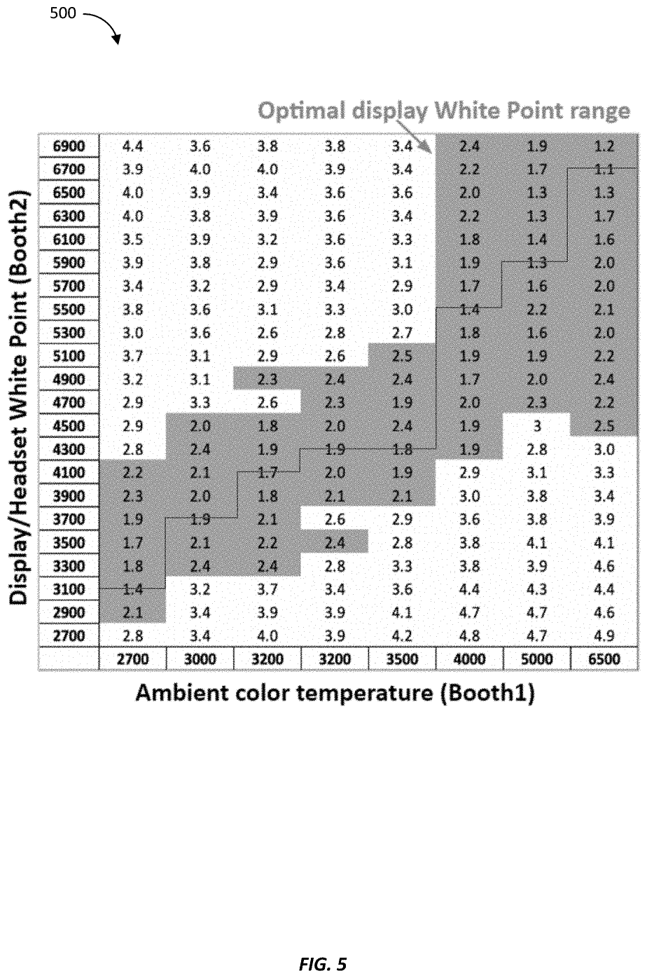

The chart provided on FIG. 5 provides the ranking results from experiment participants. The grey highlighted cells on the chart of FIG. 5 may provide the optimal display white point range for content within the MR environment at various ambient color temperatures, while the overlaid line illustrates the trend of the lowest rating, indicating the most closely match setting. The chart illustrates that there may be a proportional correlation to an ambient color temperature, provided by the ambient lighting conditions, to the white point of the VR content in the MR environment. As shown, the x-axis of the chart provides the ambient light conditions and the y-axis of the chart provides the headset white point. A lower score in this example indicates better preference. The highlighted cells in the FIG. 4 chart may illustrate preferred regions for the algorithm because the highlighted cells provide preferred mapping between display white point setting (in the unit of CCT) and the ambient CCT is the algorithm.

When combining VR content with PT content in an MR environment, there may be an acceptable color error for mixing the content. For example, there may be an acceptable error in which the VR content can vary from the color scheme of the PT content before it becomes identifiable and/or uncomfortable for a user. The full system color may have an error of 6 ΔEab with a camera specification of 5.4 ΔE and a display specification of 2.7 ΔE. Delta E (“ΔE”) is a metric for “color difference.” A lower delta E may be preferred. The acceptable error range for VR content may vary depending on the color(s) of the VR content and/or the PT content.

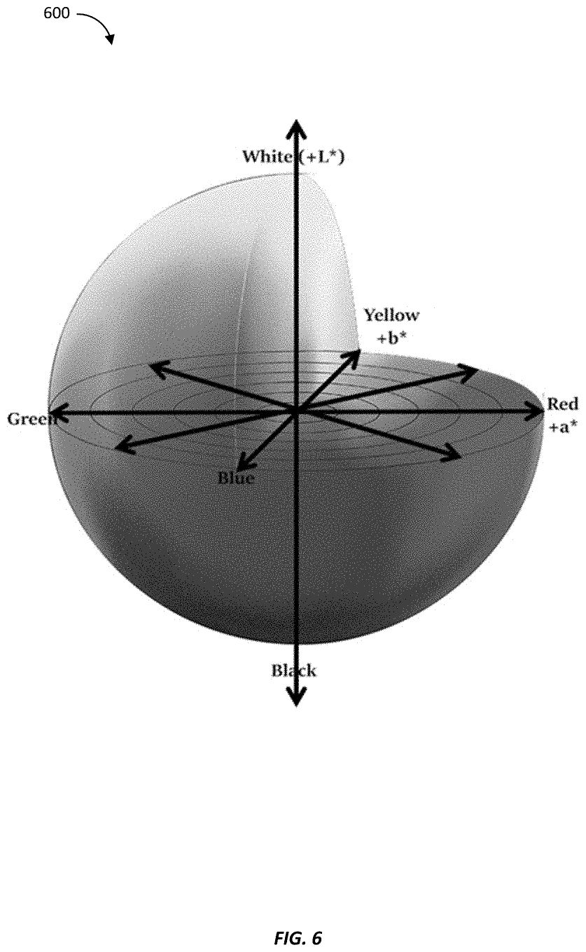

Turning now to FIG. 6, a color sphere 600 is shown. The color appearance of virtually white objects may be the most challenging, followed by gray, and then chromatic objects. The difference of white matching between the VR content and PT content should be within a threshold, such as between −20% and +50%. The degree, however, to which a VR content and PT content is matched may depend on the color scheme of the VR and PT content. For example, on the color sphere provided in FIG. 5, the differences in color a and b directions should be within ±4 and ±6 units.

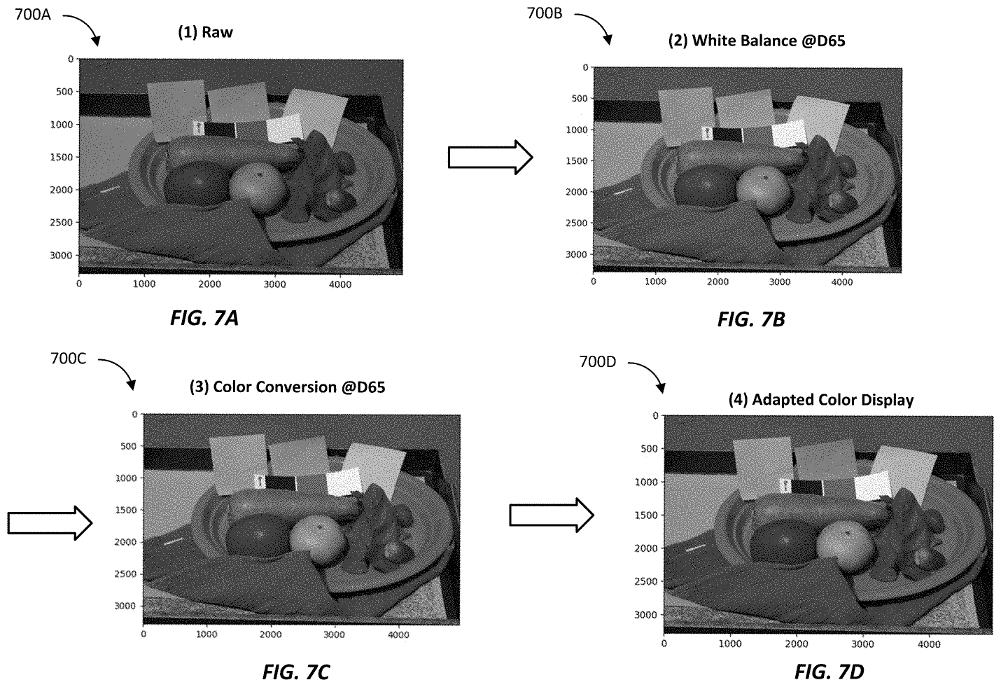

In another illustrative example, FIGS. 7A-7D illustrate a flow for how adaptive mixed reality may be provided. FIG. 7A shows a raw image including VR content generated in a MR environment without adapting to ambient lighting conditions. For example, the ambient lighting condition may be D65. The MR headset may then estimate the ambient lighting condition to be D65. Then, at FIG. 7B, the VR content may then be white balanced to be D65 based on the MR headset's determination. At FIG. 7C, the VR content may then be modified based on a color temperature according to D65. Finally, at FIG. 7D, the VR content may be provided in the MR environment as an adapted MR display. The VR content may be displayed along with the PT content, and both the VR content and the PT content are then merged in a MR environment. Because both the PT content (real world content) and the VR content is adjusted to employ lighting at a D65 white point and the corresponding color temperature at D65, both types of content match in the MR environment.

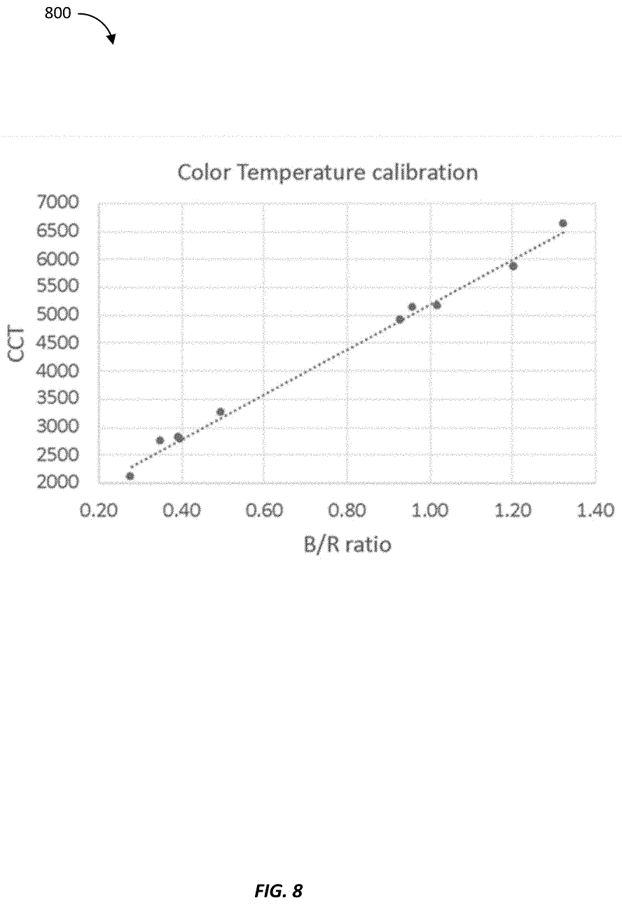

Turning now to FIG. 8, a graph is provided for determining a color temperature calibration. As described above, the image sensors may be spectrally calibrated. The graph of FIG. 8 provides an example of how the sensors may be spectrally calibrated for color temperature calibration. As illustrated, a CCT for a given B/R ratio may be calibrated by correlating the CCT and B/R ratio.

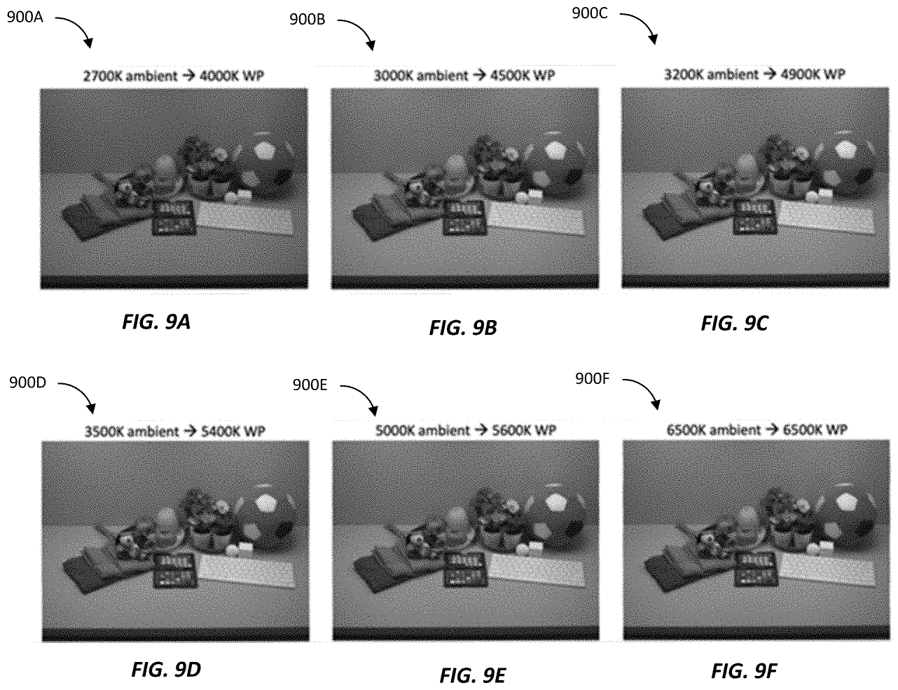

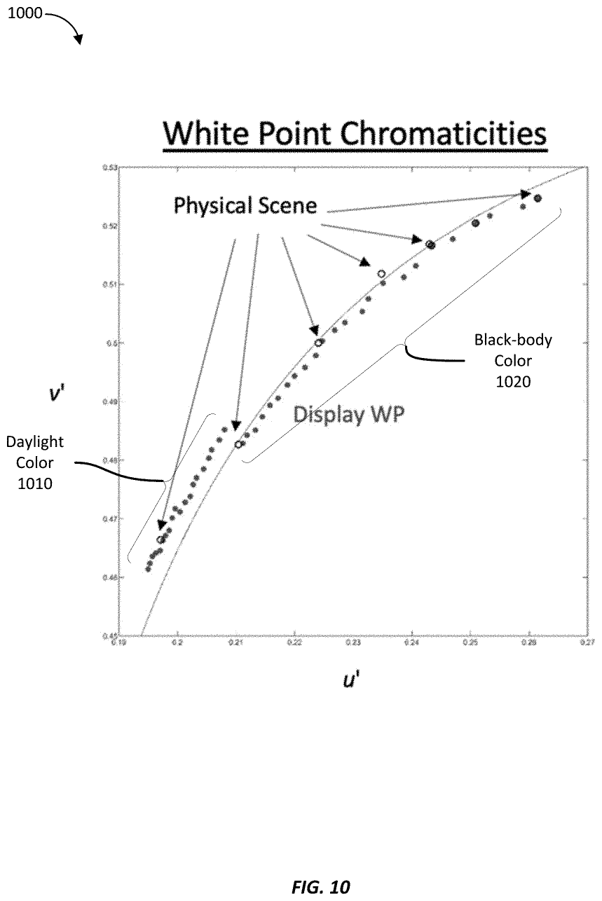

Turning now to FIGS. 9A-9F and 10, an example of how modifying a white point of an MR environment, including VR content and PT content, based on ambient lighting conditions is provided. As illustrated, FIGS. 9A-9F provide six images at varying ambient conditions in which the white point of the VR content is modified. For example, FIG. 9A provides an MR environment in which the ambient lighting conditions are at 2500K and the VR content is modified to 4000K, FIG. 9B provides an MR environment in which the ambient lighting conditions are at 3000K and the VR content is modified to 4500K, FIG. 9C provides an MR environment in which the ambient lighting conditions are at 3200K and the VR content is modified to 4900K, FIG. 9D provides an MR environment in which the ambient lighting conditions are at 3500K and the VR content is modified to 5400K, FIG. 9E provides an MR environment in which the ambient lighting conditions are at 5000K and the VR content is modified to 5600K, and FIG. 9F provides an MR environment in which the ambient lighting conditions are at 6500K and the VR content is modified to 6500K.

FIG. 10 provides a graph based on the images provided in FIGS. 9A-9F of white point chromaticities. The graph of FIG. 10 correlates u′ and v′ color coordinates in a CIE1976 space. The solid red dots may be display white points and the black circles may be a sensor reading for an ambient color. Thus, based on the detected white point within a scene by a sensor, a different display white point may be selected.

However, FIG. 10 also illustrates that discontinuities may occur in certain cases, such as at a transition point from a daylight color region 1010 to a black-body color region 1020. Such a discontinuity can be perceivable by a person in some cases. To address the discontinuity, example systems or methods may employ interpolation between the two curves to help reduce or eliminate the discontinuity, thereby eliminating potential undesirable visual effects.

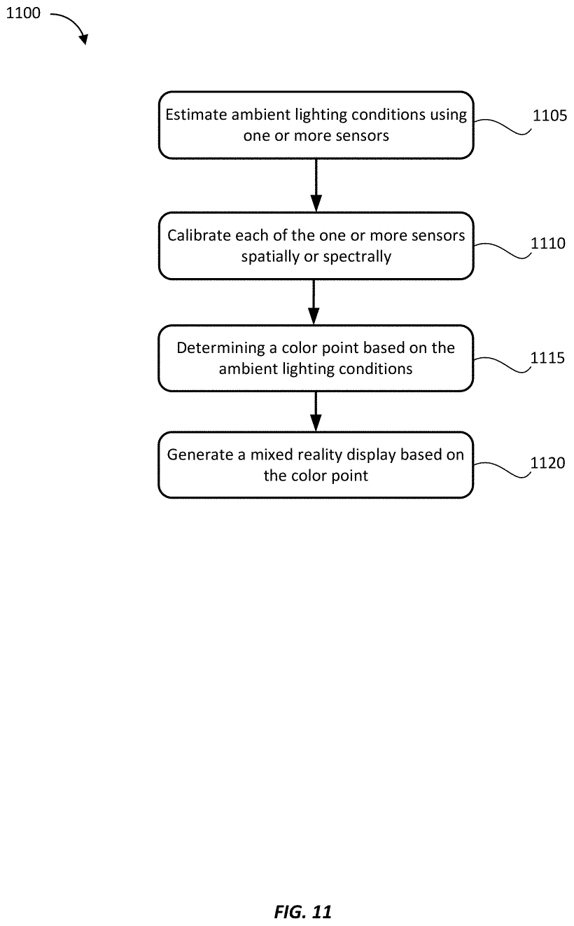

Referring now to FIG. 11, FIG. 11 shows an example method for adaptive MR. The example method 1100 will be described with respect to the system 100 shown in FIG. 1; however, any suitable MR system may be employed.

At block 1105, the MR system 100 estimates ambient lighting conditions using one or more sensors. As discussed above, a MR system 100 may include a HMD 105 that includes one or more light sensors, which may include one or more MR cameras. The light sensors capture light information within a real-world scene and can estimate various ambient lighting conditions, such as the locations, sizes, spectra, CCT, or RGB characteristics of the detected light sources. In some examples, the sensors themselves may make such estimations; however, in other examples, sensor information may be provided to a processor within the HMD 105 or in an associated processing system 110, which may then estimate the ambient lighting conditions.

At block 1110, the MR system 100 calibrates each of the one or more sensors. As discussed above with respect to FIG. 2, the sensors may be calibrated to detect different characteristics of the respective zone. The characteristics may include a white point, color temperatures, light sources and related characteristics (e.g., location, CCT, etc. as discussed above). In addition, different sensors may be assigned to different portions of a real-world scene, such as by subdividing the field of view into different zones and allocating sensors to various zones, each of which may be individually calibrated for its respective zone. Further, a single sensing device may provide multiple sensors, such as by allocating one or more pixels of an image sensor as a sensor, thus allowing the image sensor to provide multiple different zone sensors.

At block 1115, the MR system 100 determines a color point based on the ambient lighting conditions. As discussed above, the MR system 100 may determine a white point for a real-world scene or it may determine a color temperature of an identified light source. In some examples, the MR system 100 may determine multiple color points, such as if multiple different light sources are detected within a real-world scene. Further, in examples where different sensors are assigned to different zones, each sensor may provide information from which a color point for the respective zone may be determined.

At block 1120, the MR system 100 generates a MR display based on the color point. As discussed above, the MR system 100 adjusts the PT or VR content based on the determined color point. For example, the MR system 100 may adjust the white point or color temperature of the VR content to match the PT content. In some examples the MR system 100 may adjust captured PT content before display, similar to how it would adjust VR content prior to display. In some examples, the MR system 100 may output a notification to the user to adjust ambient lighting conditions to better match to the VR content, such as by increasing a brightness in the real-world environment, closing a window shade, or by adjusting a color of a light source. Further, based on the mix of PT and VR content 310, 320, such as shown in FIG. 3, adjustments may be weighted towards the VR content in a MR scene with a larger percentage of PT content, or if a scene is predominantly VR content 320, adjustments may be made primarily to the PT content instead.

In some examples, the PT content or layers may be rendered by a separate service that is distinct from client applications. This may provide security to a MR session as client applications may not have full control of, or access to, PT content as it is based on a user's ambient environment.

The method 1100 then iteratively repeats for as long as MR content is being provided to the user to provide a more realistic, immersive MR experience.

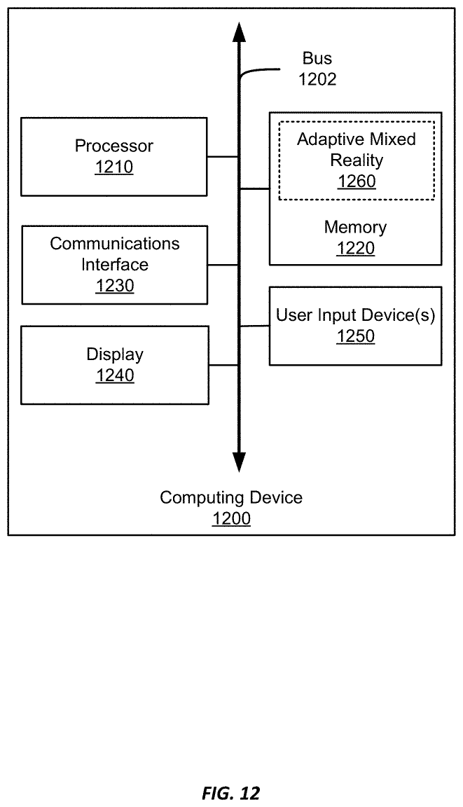

Referring now to FIG. 12, FIG. 12 shows an example computing device 1200 suitable for use in example systems or methods for adaptive mixed reality according to this disclosure. The example computing device 1200 includes a processor 1210 which is in communication with the memory 1220 and other components of the computing device 1200 using one or more communications buses 1202. The processor 1210 is configured to execute processor-executable instructions stored in the memory 1220 to perform one or more methods for adaptive mixed reality according to different examples, such as part or all of the example method 1100 described above with respect to FIG. 11. The computing device 1200, in this example, also includes one or more user input devices 1250, such as a keyboard, mouse, touchscreen, microphone, etc., to accept user input, though such input devices are optional according to various examples. The computing device 1200 also includes a display 1240 to provide visual output to a user. In addition, the computing device 1200 includes an adaptive mixed reality application 1260 to provide adaptive mixed reality functionality, such as by the processing system 110 shown in FIG. 1 and described throughout this specification.

The computing device 1200 also includes a communications interface 1240. In some examples, the communications interface 1230 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

All patents, patent publications, patent applications, journal articles, books, technical references, and the like discussed in the instant disclosure are incorporated herein by reference in their entirety for all purposes.

Articles “a” and “an” are used herein to refer to one or to more than one (i.e., at least one) of the grammatical object of the article. By way of example, “an element” means at least one element and can include more than one element.

“About” is used to provide flexibility to a numerical range endpoint by providing that a given value may be “slightly above” or “slightly below” the endpoint without affecting the desired result.

The use herein of the terms “including,” “comprising,” or “having,” and variations thereof, is meant to encompass the elements listed thereafter and equivalents thereof as well as additional elements. Embodiments recited as “including,” “comprising,” or “having” certain elements are also contemplated as “consisting essentially of” and “consisting of” those certain elements. As used herein, “and/or” refers to and encompasses any and all possible combinations of one or more of the associated listed items, as well as the lack of combinations where interpreted in the alternative (“or”).

It is to be understood that the figures and descriptions of the disclosure have been simplified to illustrate elements that are relevant for a clear understanding of the disclosure. It should be appreciated that the figures are presented for illustrative purposes and not as construction drawings. Omitted details and modifications or alternative embodiments are within the purview of persons of ordinary skill in the art.

It can be appreciated that, in certain aspects of the disclosure, a single component may be replaced by multiple components, and multiple components may be replaced by a single component, to provide an element or structure or to perform a given function or functions. Except where such substitution would not be operative to practice certain embodiments of the disclosure, such substitution is considered within the scope of the disclosure.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

That which is claimed is:

1. A method for providing an adaptive mixed reality session, the method comprising:
estimating ambient lighting conditions using one or more sensors;
calibrating each of the one or more sensors spatially or spectrally;
determining a color point based on the ambient lighting conditions; and
modifying a mixed reality display based on the color point, wherein the mixed reality display comprises virtual reality (VR) content and pass-through (PT) content.

2. The method of claim 1, wherein the color point comprises one or more of a white point or a color temperature.

3. The method of claim 1, wherein calibrating each of the one or more sensors comprises calibrating a RGB rating of the one or more sensors to a correlated color temperature (CCT) to determine a CCT rating.

4. The method of claim 1, wherein calibrating the one or more sensors comprises dividing each of the sensors into a plurality of zones and calibrating each of the zones individually.

5. The method of claim 1, wherein the plurality of zones comprises 1 to 100 zones.

6. The method of claim 1, wherein estimating the ambient lighting conditions using the one or more sensors comprises gathering lighting data from an ambient environment using the one or more sensors for a period of time.

7. The method of claim 6, wherein gathering the lighting data from the ambient lighting conditions using the one or more sensors comprises reducing a sensitivity level of the one or more sensors.

8. A non-transitory computer-readable medium comprising processor-executable instructions configured to cause one or more processors to:
estimate ambient lighting conditions using one or more sensors;
calibrate each of the one or more sensors spatially or spectrally;
determine a color point based on the ambient lighting conditions; and
modify a mixed reality display based on the color point, wherein the mixed reality display comprises virtual reality (VR) content and pass-through (PT) content.

9. The non-transitory computer-readable medium of claim 8, wherein the color point comprises one or more of a white point or a color temperature.

10. The non-transitory computer-readable medium of claim 8, wherein the processor-executable instructions to calibrate each of the one or more sensors spatially or spectrally further include processor-executable instructions that cause the one or more processors to correlate a RGB rating of the one or more sensors to a correlated color temperature (CCT) to determine a CCT rating.

11. The non-transitory computer-readable medium of claim 8, wherein the processor-executable instructions to calibrate each of the one or more sensors spatially or spectrally further include processor-executable instructions that cause the one or more processors to divide each of the one or more sensors into a plurality of zones and calibrate each of the zones individually.

12. The non-transitory computer-readable medium of claim 11, wherein the plurality of zones comprises 1 to 100 zones.

13. The non-transitory computer-readable medium of claim 8, wherein the processor-executable instructions to modify the mixed reality display further include processor-executable instructions that cause the one or more processors to modify the VR content of the mixed reality display based on the color point.

14. The non-transitory computer-readable medium of claim 13, wherein the processor-executable instructions to modify the VR content of the mixed reality display further include processor-executable instructions that cause the one or more processors to match a VR color point of the VR content to the color point of the PT content.

15. A system comprising:
one or more sensors;
a mixed reality display;
one or more processors communicatively coupled to the one or more sensors and the mixed reality display; and
a non-transitory computer-readable medium communicatively coupled to the one or more processors, wherein the one or more processors are configured to execute processor-executable instructions stored in the non-transitory computer-readable medium to:
estimate ambient lighting conditions using the one or more sensors;
calibrate each of the one or more sensors spatially or spectrally;
determine a color point based on the ambient lighting conditions; and
modify the mixed reality display based on the color point, wherein the mixed reality display comprises virtual reality (VR) content and pass-through (PT) content.

16. The system of claim 15, wherein the one or more sensors are part of a virtual reality headset.

17. The system of claim 15, wherein processor-executable instructions to estimate the ambient lighting conditions using the one or more sensors further include processor-executable instructions that cause the one or more processors to gather lighting data from an ambient environment using the one or more sensors for a period of time.

18. The system of claim 17, wherein processor-executable instructions to gather the lighting data from the ambient lighting conditions using the one or more sensors further include processor-executable instructions that cause the one or more processors to reduce a sensitivity level of the one or more sensors.

19. The system of claim 15, wherein the color point comprises one or more of a white point or a color temperature.

20. The system of claim 15, wherein calibrating each of the one or more sensors comprises calibrating a RGB rating of the one or more sensors to a correlated color temperature (CCT) to determine a CCT rating.
